(19) United States
(12) Patent Application Publication
(10) Pub. No.: US 2026/0008332 A1
(43) Pub. Date: Jan. 8, 2026

(54) DRIVING WHEEL

(71) Applicants: Hui Zhang, Zhejiang (CN); Sizong Yi, Zhejiang (CN); An Huangfu, Zhejiang (CN)

(72) Inventors: Hui Zhang, Zhejiang (CN); Sizong Yi, Zhejiang (CN); An Huangfu, Zhejiang (CN)

(21) Appl. No.: 18/978,001

(22) Filed: Dec. 12, 2024

(30) Foreign Application Priority Data
Jul. 4, 2024 (CN) 202421574649X

(51) Int. Cl. B60K 7/00; B60B 27/00; B60B 37/10; B60K 17/04; F16H 1/20

(52) U.S. Cl. CPC B60K 7/0007; B60B 27/0015; B60B 37/10; B60K 17/043; F16H 1/203; B60B 2900/112; B60B 2900/113; B60B 2900/131; B60B 2900/325

(57) ABSTRACT

A driving wheel comprises an axle, a wheel body, and a driving assembly. The wheel body is of a hollow structure and is rotatably arranged on the axle. The driving assembly comprises a shell, a motor, and a transmission mechanism. The shell is fixedly arranged on the axle and located in the wheel body, and the motor is fixedly arranged in the shell and connected to the wheel body by the transmission mechanism. An output shaft of the motor is arranged perpendicular to the axle, which can reduce the space occupied by the motor and improve space utilization.

### TECHNICAL FIELD

The present invention relates to the field of camping vehicles, in particular to a driving wheel of a camping vehicle.

### BACKGROUND OF THE INVENTION

Chinese patent document No. CN116834886A discloses a hub-driven integrated wheel of a baby carriage, comprising a hub and a gearbox installed inside the hub, where a tire is arranged on an outer circumference of the hub; the gearbox is clamped to the hub, to drive the integrated wheel to move; the gearbox comprises a gearbox body, the gearbox body comprises a gear fixing upper cover and a gear fixing lower cover, an accommodating cavity is formed between the gear fixing upper cover and the gear fixing lower cover, and a gear transmission mechanism is assembled in the accommodating cavity; a limit groove is formed inside an outer side of the gear fixing upper cover in a width direction of the integrated wheel, and a driving motor is assembled in the limit groove, where the driving motor is longitudinally assembled in the limit groove, a driving shaft of the driving motor passes through the gear fixing upper cover and is connected to a gear, and the gear is connected to the gear transmission mechanism.

In the above solution, the driving motor is longitudinally assembled in the limit groove, but in actual assembly, the driving motor needs to have power for driving the gear to rotate, making a main body of the driving motor large. During installation, a larger hub is required to accommodate the main body of the driving motor and install the motor, which undoubtedly greatly increases the assembly cost and cannot better utilize the remaining space in the hub.

### BRIEF SUMMARY OF THE INVENTION

The objective of the present invention is to provide a driving wheel with a reasonable structure and high space utilization.

To achieve the above objective, the technical solution adopted by the present invention is as follows:

A driving wheel, comprising an axle, a wheel body, and a driving assembly, wherein the wheel body is of a hollow structure and is rotatably arranged on the axle; the driving assembly comprises a shell, a motor, and a transmission mechanism; the shell is fixedly arranged on the axle and located in the wheel body, the motor is fixedly arranged in the shell and connected to the wheel body by the transmission mechanism, and an output shaft of the motor is arranged perpendicular to the axle.

By adopting the above solution, the shell is fixed on the axle and located in the wheel body, and the motor is fixed in the shell and connected to the wheel body by the transmission mechanism. During installation, the motor and the transmission mechanism can be first installed in the shell, and then the shell is installed in the wheel body, which can facilitate product assembly. The output shaft of the motor is arranged perpendicular to the axle, so that the motor can be arranged in the shell to reduce the space occupied by the motor, improve space utilization and further facilitate the product assembly.

The transmission mechanism comprises a worm and a worm gear, the worm is arranged on the output shaft of the motor, and the worm gear is rotatably arranged in the shell and meshes with the worm.

By adopting the above solution, the worm arranged on the output shaft of the motor can drive the worm gear to rotate, so that the cooperation of the worm and the worm gear can change the direction of force from the output shaft of the motor, and can also make the worm gear more stable during rotation.

The transmission mechanism further comprises a first transition gear, a second transition gear, a third transition gear, a main gear, and a transmission member; the first transition gear and the worm gear are arranged coaxially and connected to each other, the second transition gear and the third transition gear are arranged coaxially and connected to each other, the main gear is rotatably sleeved on the axle, the first transition gear meshes with the second transition gear, the third transition gear meshes with the main gear, and the transmission member is connected between the main gear and the wheel body.

By adopting the above solution, the first transition gear and the worm gear are arranged coaxially and connected to each other, the second transition gear and the third transition gear are arranged coaxially and connected to each other, the main gear is rotatably sleeved on the axle, the first transition gear meshes with the second transition gear, and the third transition gear meshes with the main gear, which can improve transmission efficiency between the gears and ensure reliability.

A clamping groove is formed at one end of the transmission member, and a clamping block engaged with the clamping groove is provided on the wheel body.

By adopting the above solution, the clamping groove is formed at one end of the transmission member, and the clamping block engaged with the clamping groove is provided on the wheel body, so that the cooperation of the clamping groove and the clamping block can make the assembly of the transmission member more convenient.

A receiving groove is formed at the other end of the transmission member, the main gear is provided with an adapter portion located in the receiving groove, the adapter portion is fixedly sleeved with a metal sleeve, the metal sleeve is formed with a flat step surface, a cylindrical magnet is arranged between the receiving groove and the step surface, a positioning sleeve is fixedly sleeved on the axle, the positioning sleeve has a metal plate opposite to an end surface of the main gear, the cylindrical magnet is located between the metal plate and the end surface of the main gear, an end surface of the cylindrical magnet is adsorbed by the metal plate, a peripheral surface of the cylindrical magnet is adsorbed by the step surface, and a plurality of arc-shaped recesses adapted to the cylindrical magnet is formed on a wall of the receiving groove; when the main gear rotates, the cylindrical magnet can be embedded in the arc-shaped recesses to connect the adapter portion and the transmission member.

By adopting the above solution, when the main gear rotates, the metal sleeve and the positioning sleeve are driven to rotate, the cylindrical magnet adsorbed between the positioning sleeve and the metal sleeve rotates with the metal sleeve to the arc-shaped recesses of the receiving groove to get stuck and drive the wheel body to rotate, the receiving groove of the transmission member can facilitate the installation of the main gear, and the cooperation of the main gear, the cylindrical magnet, the metal sleeve, the metal plate, and the receiving groove enables the wheel body to rotate under the drive of the motor.

The shell comprises a first side plate, a second side plate, and an annular outer plate; the first side plate is arranged in parallel to and spaced apart from the second side plate, the annular outer plate is connected between outer edges of the first side plate and the second side plate, the first side plate and the annular outer plate are integrally formed, the first side plate is formed with a first avoidance hole for the axle to pass through, the second side plate is formed with a second avoidance hole for the transmission member to pass through, the second side plate is locked and connected to the first side plate by fasteners, the motor and the transmission mechanism are arranged in the shell, a first pivot shaft for supporting the worm gear and a second pivot shaft for supporting the second transition gear and the third transition gear are provided between the first side plate and the second side plate, and a first insertion hole and a second insertion hole for inserting the first pivot shaft and the second pivot shaft are formed on the first side plate and the second side plate separately.

By adopting the above solution, the first side plate is formed with the first avoidance hole for the axle to pass through, the second side plate is formed with the second avoidance hole for the transmission member to pass through, the first pivot shaft for supporting the worm gear and the second pivot shaft for supporting the second transition gear and the third transition gear are provided between the first side plate and the second side plate, the insertion holes for inserting the first pivot shaft and the second pivot shaft are formed on the first side plate and the second side plate separately, and the second side plate is locked and connected to the first side plate by fasteners, making the assembly more convenient.

the wheel body comprises two half wheel bodies, the two half wheel bodies are buckled oppositely and locked by fasteners to form the wheel body, the half wheel bodies comprise circular panels and an annular peripheral panel, one side edge of the peripheral panel is connected to peripheral edges of the circular panels, the circular panels and the peripheral panel are integrally formed, and centers of the circular panels are rotatably connected to the axle by a bearing.

By adopting the above solution, the shell is installed into the half wheel bodies through the axle, and then the two half wheel bodies are buckled and locked by fasteners, which can facilitate assembly.

The axle is formed with a through hole that penetrates axially, and a wire hole in communication with the shell is formed on a peripheral surface of the axle.

By adopting the above solution, the wire hole and the through hole formed on the axle can facilitate circuit connection of the motor and make internal circuit layout more reasonable.

A connecting plate is fixedly provided on the axle, the shell is formed with a groove adapted to the connecting plate, and the connecting plate is embedded in the groove and fixedly connected to the shell by fasteners.

By adopting the above solution, the groove adapted to the connecting plate is formed in the shell, which facilitates the installation of the connecting plate; and the connecting plate is fixedly connected to the axle, which can further improve the stability of the axle.

### BRIEF DESCRIPTION OF THE DRAWINGS

FIG. 1 is a perspective view of the present invention.

FIG. 2 is an exploded view of the present invention.

FIG. 3 is an exploded view of the present invention from another perspective.

FIG. 4 is a front view of the present invention.

FIG. 5 is a cross-sectional view taken along line A-A in FIG. 4.

FIG. 6 is a front view of the present invention after being rotated 90°.

FIG. 7 is a cross-sectional view taken along line B-B in FIG. 6.

FIG. 8 is a cross-sectional view showing that a cylindrical magnet holds an arc-shaped recess.

FIG. 9 is a perspective view of some driving components.

FIG. 10 is an exploded view of a transmission member and some related components.

FIG. 11 is an exploded view of the transmission member and some related components from another perspective.

### DETAILED DESCRIPTION OF THE INVENTION

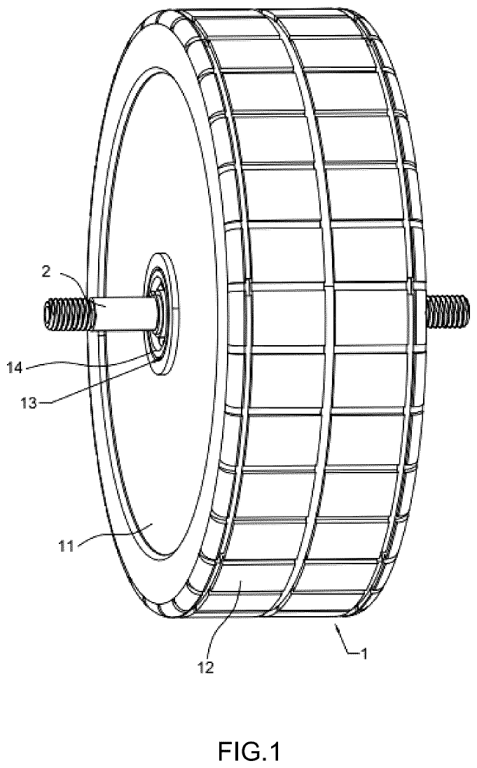

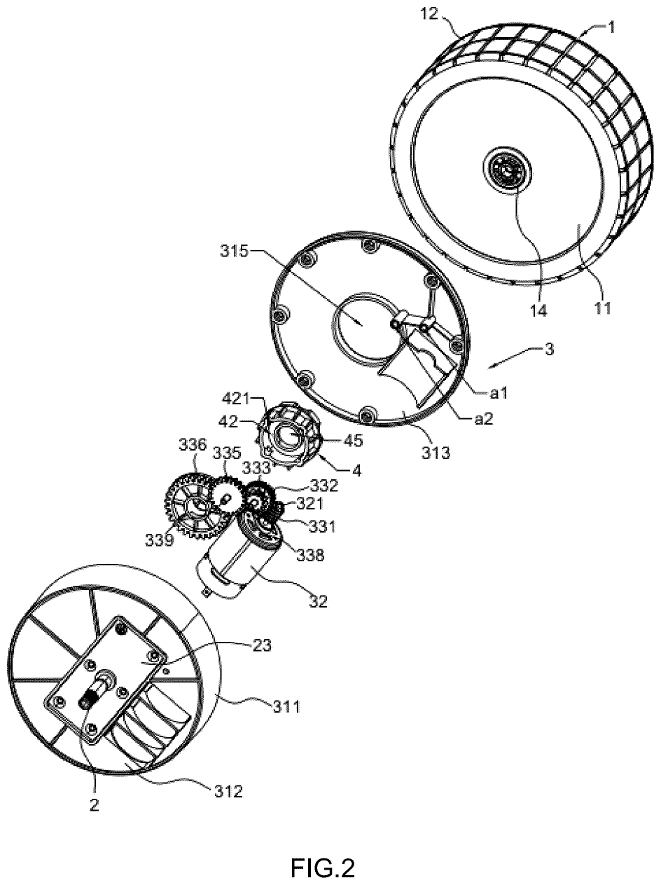

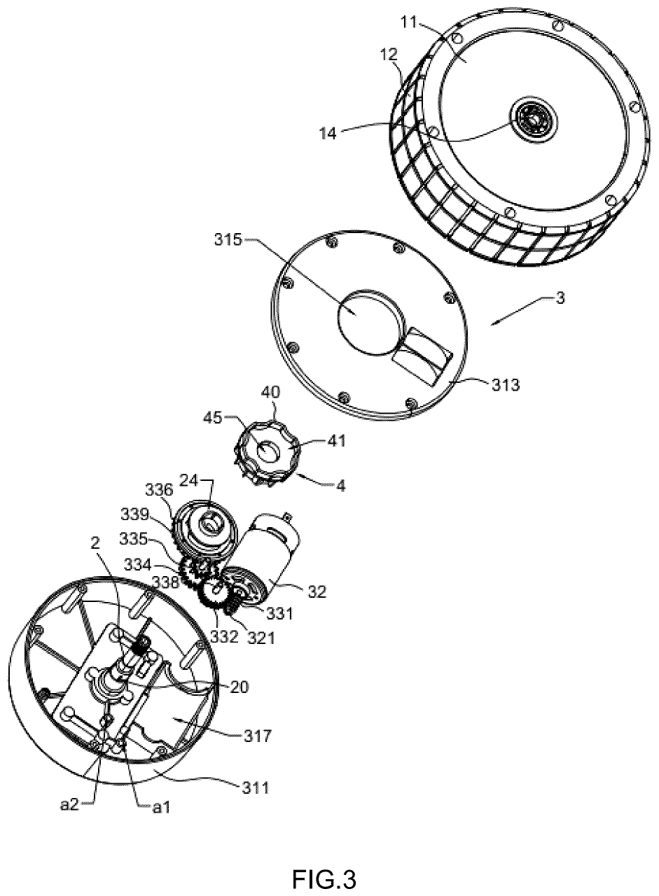

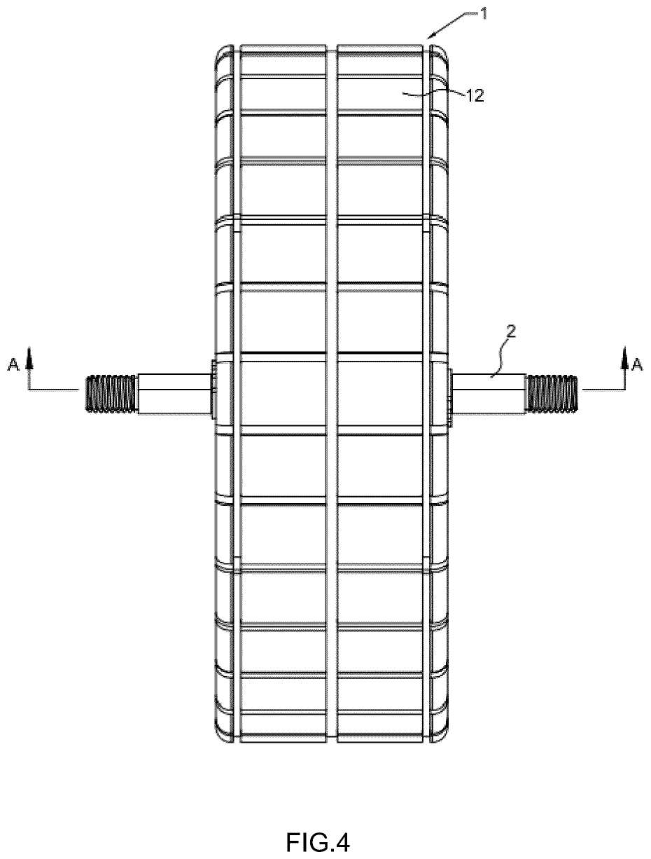

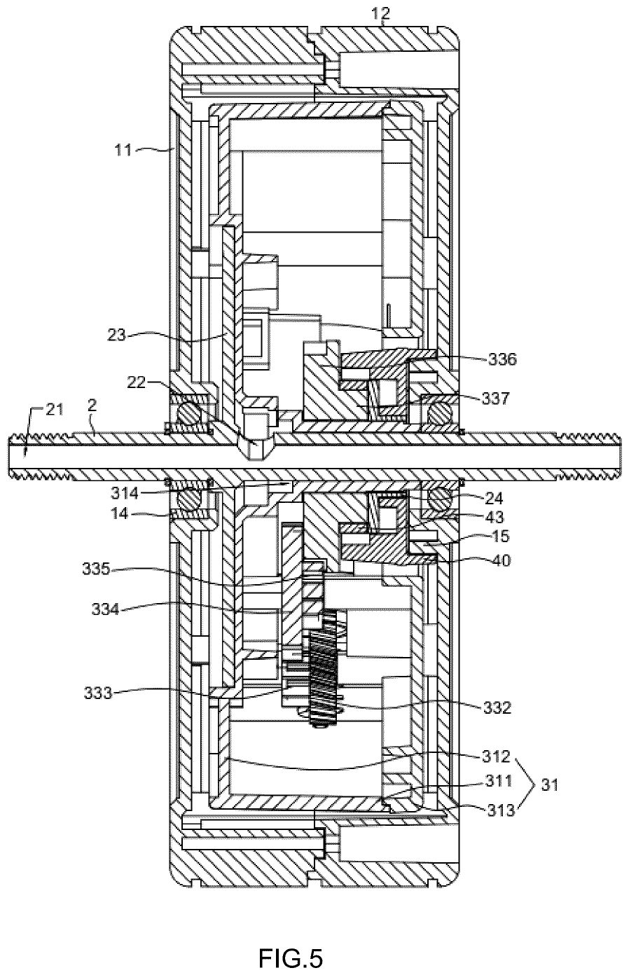

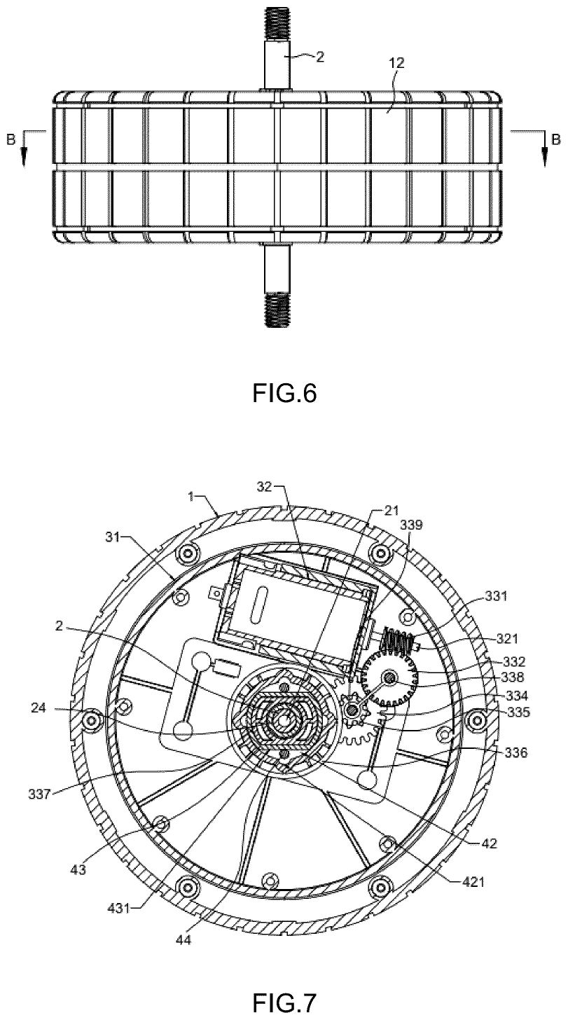

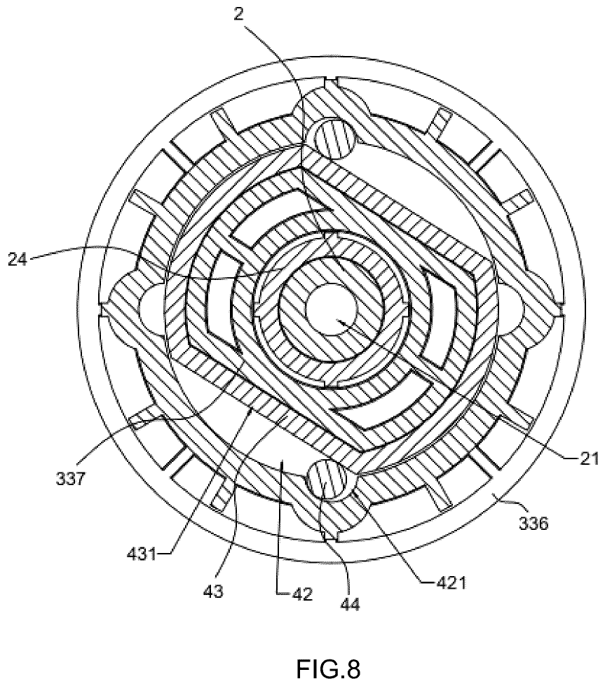

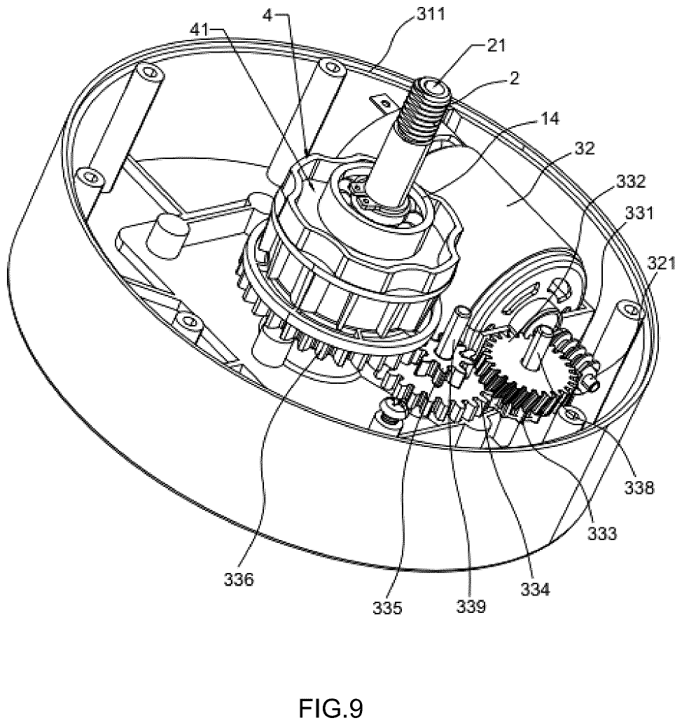

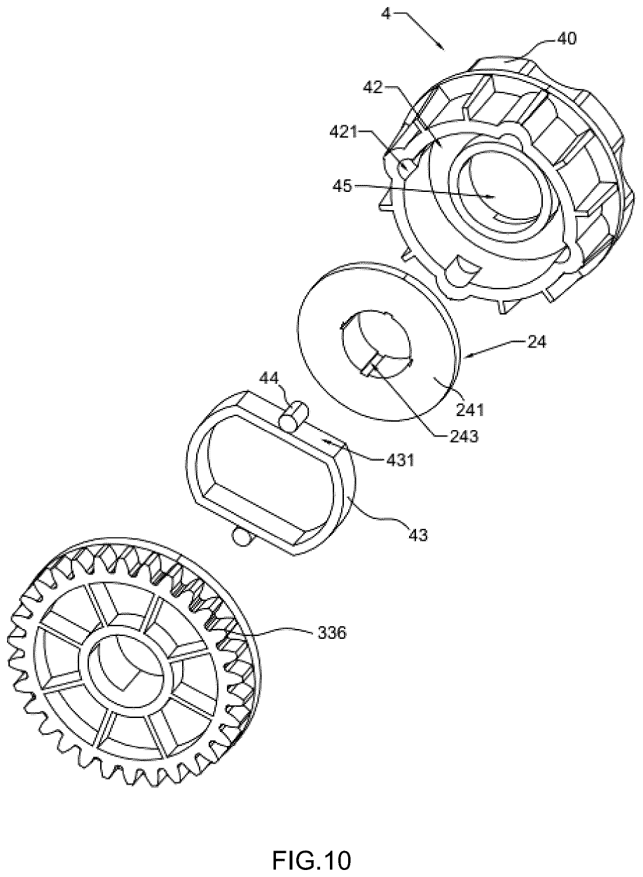

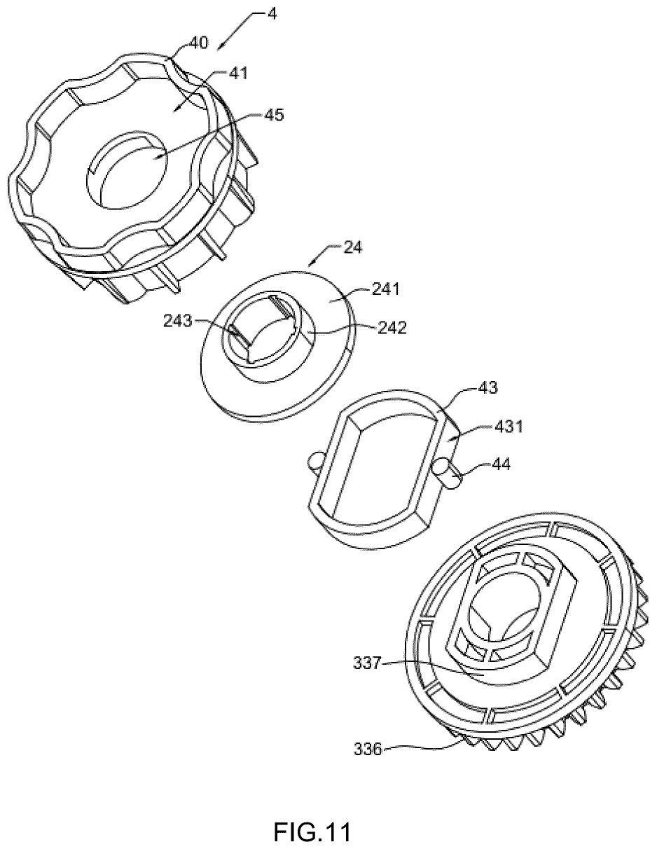

With reference to FIG. 1 to FIG. 11, the technical solution of the present invention will be further explained below through specific embodiments and in conjunction with the accompanying drawings.

A driving wheel comprises a wheel body 1, an axle 2, and a driving assembly 3.

The wheel body 1 comprises two half wheel bodies, the two half wheel bodies are buckled oppositely and locked by fasteners to form the wheel body 1, the half wheel bodies comprise two circular panels 11 and an annular peripheral panel 12, one side edge of the peripheral panel 12 is connected to peripheral edges of the two circular panels 11, and the wheel body 1 is of a hollow structure. The two circular panels 11 and the peripheral panel 12 are integrally formed, an avoidance hole 13 is formed in a center of each of the two circular panels 11, a bearing 14 is provided in the avoidance hole 13, and the wheel body 1 is rotatably connected to the axle 2 by the bearing 14.

The driving assembly 3 comprises a shell 31, a motor 32, and a transmission mechanism 33. The shell 31 is fixedly arranged on the axle 2 and located in the wheel body 1, the axle 2 is formed with a through hole 21 that penetrates axially, and a wire hole 22 in communication with the shell 31 is formed on a peripheral surface of the axle 2. A connecting circuit of the motor 32 can pass through the wire hole 22 and the through hole 21, which can facilitate circuit connection of the motor 32 and make internal circuit layout more reasonable. The shell 31 comprises an annular outer plate 311, a first side plate 312, and a second side plate 313. The first side plate 312 is arranged in parallel to and spaced apart from the second side plate 313, the annular outer plate 311 is connected between outer edges of the first side plate 312 and the second side plate 313, the first side plate 312 and the annular outer plate 311 are integrally formed, the first side plate 312 is formed with a first avoidance hole 314 for the axle 2 to pass through, and the second side plate 313 is locked and connected to the first side plate 312 by bolts. A connecting plate 23 is formed on the axle 2, and the connecting plate 23 is integrally formed with the axle 2. The connecting plate 23 is fixed by bolts in a groove 316 adapted to the connecting plate 23 on an end surface of the first side plate 312. During installation, the groove 316 can play a role in positioning and stabilizing the axle 2 during use, making the installation of the axle 2 more convenient. A second avoidance hole 315 for the transmission mechanism 33 to pass through is formed on an end surface of the second side plate 313, and the motor 32 and the transmission mechanism 33 are arranged in the shell 31. A first pivot shaft 338 for supporting a worm gear 332 and a second pivot shaft 339 for supporting a second transition gear 334 and a third transition gear 335 are provided between the first side plate 312 and the second side plate 313. A first insertion hole a1 and a second insertion hole a2 for inserting the first pivot shaft 338 and the second pivot shaft 339 are formed on the first side plate 312 and the second side plate 313 separately.

The motor 32 is fixedly arranged on a fixing groove 317 adapted to the motor 32 on the first side plate 312, and is connected to the wheel body 1 through the transmission mechanism 33. An output shaft 321 of the motor 32 is arranged perpendicular to the axle 2, so that the motor 32 can be horizontally arranged in the shell 31 to reduce the space occupied by the motor 32.

The transmission mechanism 33 comprises a worm 331, the worm gear 332, a first transition gear 333, the second transition gear 334, the third transition gear 335, a main gear 336, and a transmission member 4. The worm 331 is arranged on the output shaft 321 of the motor 32, and the worm gear 332 is rotatably arranged in the shell 31 and meshes with the worm 331, so that the worm 331 arranged on the output shaft 321 of the motor 32 can drive the worm gear 332 to rotate. The cooperation of the worm 331 and the worm gear 332 can change the direction of force from the output shaft 321 of the motor 32, and can also make the worm gear 332 more stable during rotation. The first transition gear 333 and the worm gear 332 are arranged coaxially and connected to each other, the second transition gear 334 and the third transition gear 335 are arranged coaxially and connected to each other, and the main gear 336 is rotatably sleeved on the axle 2. The first transition gear 333 meshes with the second transition gear 334, and the third transition gear 335 meshes with the main gear 336, which can improve transmission efficiency between the gears and ensure reliability. The transmission member 4 is connected between the main gear 336 and the wheel body 1, a clamping groove 41 composed of a protrusion 40 is formed at one end of the transmission member 4, and a clamping block 15 engaged with the clamping groove 41 is provided on the wheel body 1. The cooperation of the clamping groove 41 and the clamping block 15 makes the assembly of the transmission member 4 more convenient. A receiving groove 42 is formed at the other end of the transmission member 4, the main gear 336 is provided with an adapter portion 337 located in the receiving groove 42, the adapter portion 337 is fixedly sleeved with a metal sleeve 43, the metal sleeve 43 is formed with a flat step surface 431, a cylindrical magnet 44 is arranged between the receiving groove 42 and the step surface 431, a positioning sleeve 24 is further fixedly sleeved on the axle 2, the positioning sleeve 24 has a metal plate 241 opposite to an end surface of the main gear 336 and a limit protrusion 242, a through hole 45 for the limit protrusion 242 to pass through is formed on the transmission member 4, a limit groove 243 is formed in the through hole 45, the limit groove 243 can cooperate with a limit block 20 arranged on the shell 31 to limit the rotation of the positioning sleeve 24, the cylindrical magnet 44 is located between the metal plate 241 and the end surface of the main gear 336, an end surface of the cylindrical magnet 44 is adsorbed by the metal plate 241, a peripheral surface of the cylindrical magnet 44 is adsorbed by the step surface 431, and a plurality of arc-shaped recesses 421 adapted to the cylindrical magnet 44 is formed on a wall of the receiving groove 42. When the main gear 336 rotates, the metal sleeve 43 is driven to rotate, the cylindrical magnet 44 adsorbed between the positioning sleeve 24 and the metal sleeve 43 rotates with the metal sleeve 43 to the arc-shaped recesses 421 of the receiving groove 42 to get stuck and drive the wheel body 1 to rotate.

During assembly, the axle 2 is first inserted into the first avoidance hole 314 of the annular outer plate 311, and the axle 2 is fixed to the annular outer plate 311 through the connecting plate 23. Then, the worm gear 332 and the first transition gear 333 located on the same axis are fixed to the first side plate 312 by the cooperation of the first pivot shaft 338 and the first insertion hole a1, the second transition gear 334 and the third transition gear 335 located on the same axis are fixed to the first side plate 312 by the cooperation of the second pivot shaft 339 and the second insertion hole a2, the main gear 336 is installed on the axle 2 and meshes with the third transition gear 335, the motor 32 is arranged perpendicular to the axle 2 in the fixing groove 317 and connected to the worm gear 332 by the worm 331 arranged on the output shaft 321, the worm gear 332 cooperates with the worm 331 arranged on the output shaft 321 of the motor 32, the metal sleeve 43 and the positioning sleeve 24 are sequentially arranged above the main gear 336 through the axle 2, and the cylindrical magnet 44 is arranged between the positioning sleeve 24 and the metal sleeve 43. Next, the transmission member 4 is sleeved on the main gear 336, the first side plate 312 and the second side plate 313 are buckled and fixed by bolts, and the end of the transmission member 4 formed with the clamping groove 41 can pass through the second avoidance hole 315 of the second side plate 313 and cooperate with the clamping block 15 formed on the wheel body 1 to ensure that the shell 31 is installed inside the wheel body 1 more stably.

During use, the output shaft 321 of the motor 32 outputs power, the power drives the worm gear 332 through the worm 331 arranged on the output shaft 321, the worm gear 332 drives the first transition gear 333 arranged coaxially, then the first transition gear 333 drives the second transition gear 334 and the third transition gear 335 arranged coaxially with the second transition gear 334, and the third transition gear 335 drives the main gear 336 to rotate. When the main gear 336 rotates, the metal sleeve 43 is driven to rotate, the cylindrical magnet 44 arranged between the metal sleeve 43 and the positioning sleeve 24 is driven by the metal sleeve 43 and the positioning sleeve 24 to rotate into the arc-shaped recesses 421 on the wall of the receiving groove 42 and get stuck to drive the transmission member 4 to rotate, and the transmission member 4 drives the wheel body 1 to rotate, so as to achieve the purpose of driving the wheel body 1 to rotate by the motor 32.

What is claimed is:

1. A driving wheel, comprising an axle, a wheel body, and a driving assembly, wherein the wheel body is of a hollow structure and is rotatably arranged on the axle; the driving assembly comprises a shell, a motor, and a transmission mechanism; the shell is fixedly arranged on the axle and located in the wheel body, the motor is fixedly arranged in the shell and connected to the wheel body by the transmission mechanism, and an output shaft of the motor is arranged perpendicular to the axle.

2. The driving wheel according to claim 1, wherein the transmission mechanism comprises a worm and a worm gear, the worm is arranged on the output shaft of the motor, and the worm gear is rotatably arranged in the shell and meshes with the worm.

3. The driving wheel according to claim 2, wherein the transmission mechanism further comprises a first transition gear, a second transition gear, a third transition gear, a main gear, and a transmission member; the first transition gear and the worm gear are arranged coaxially and connected to each other, the second transition gear and the third transition gear are arranged coaxially and connected to each other, the main gear is rotatably sleeved on the axle, the first transition gear meshes with the second transition gear, the third transition gear meshes with the main gear, and the transmission member is connected between the main gear and the wheel body.

4. The driving wheel according to claim 3, wherein a clamping groove is formed at one end of the transmission member, and a clamping block engaged with the clamping groove is provided on the wheel body.

5. The driving wheel according to claim 3, wherein a receiving groove is formed at the other end of the transmission member, the main gear is provided with an adapter portion located in the receiving groove, the adapter portion is fixedly sleeved with a metal sleeve, the metal sleeve is formed with a flat step surface, a cylindrical magnet is arranged between the receiving groove and the step surface, a positioning sleeve is fixedly sleeved on the axle, the positioning sleeve has a metal plate opposite to an end surface of the main gear, the cylindrical magnet is located between the metal plate and the end surface of the main gear, an end surface of the cylindrical magnet is adsorbed by the metal plate, a peripheral surface of the cylindrical magnet is adsorbed by the step surface, and a plurality of arc-shaped recesses adapted to the cylindrical magnet is formed on a wall of the receiving groove; when the main gear rotates, the cylindrical magnet can be embedded in the arc-shaped recesses to connect the adapter portion and the transmission member.

6. The driving wheel according to claim 3, wherein the shell comprises a first side plate, a second side plate, and an annular outer plate; the first side plate is arranged in parallel to and spaced apart from the second side plate, the annular outer plate is connected between outer edges of the first side plate and the second side plate, the first side plate and the annular outer plate are integrally formed, the first side plate is formed with a first avoidance hole for the axle to pass through, the second side plate is formed with a second avoidance hole for the transmission member to pass through, the second side plate is locked and connected to the first side plate by fasteners, the motor and the transmission mechanism are arranged in the shell, a first pivot shaft for supporting the worm gear and a second pivot shaft for supporting the second transition gear and the third transition gear are provided between the first side plate and the second side plate, and a first insertion hole and a second insertion hole for inserting the first pivot shaft and the second pivot shaft are formed on the first side plate and the second side plate separately.

7. The driving wheel according to claim 1, wherein the wheel body comprises two half wheel bodies, the two half wheel bodies are buckled oppositely and locked by fasteners to form the wheel body, the half wheel bodies comprise circular panels and an annular peripheral panel, one side edge of the peripheral panel is connected to peripheral edges of the circular panels, the circular panels and the peripheral panel are integrally formed, and centers of the circular panels are rotatably connected to the axle by a bearing.

8. The driving wheel according to claim 1, wherein the axle is formed with a through hole that penetrates axially, and a wire hole in communication with the shell is formed on a peripheral surface of the axle.

9. The driving wheel according to claim 1, wherein a connecting plate is fixedly provided on the axle, the shell is formed with a groove adapted to the connecting plate, and the connecting plate is embedded in the groove and fixedly connected to the shell by fasteners.
